(19) United States
(12) Patent Application Publication
(10) Pub. No.: US 2010/0036707 A1
(43) Pub. Date: Feb. 11, 2010

(54) MOBILE STORAGE SYSTEM AND METHOD OF MANAGING THE USE OF SAME

(75) Inventor: Adam Gilchrist, New South Wales (AU)

Correspondence Address: FENWICK & WEST LLP, SILICON VALLEY CENTER, 801 CALIFORNIA STREET, MOUNTAIN VIEW, CA, 94041, US

(73) Assignee: BEN ALDER PTY LTD, West Ryde, NSW (AU)

(21) Appl. No.: 12/304,677

(22) PCT Filed: Dec. 5, 2006
(86) PCT No.: PCT/AU2006/001841

§ 371 Date: Oct. 21, 2009

(30) Foreign Application Priority Data
Jun. 14, 2006 (AU) 2006903223

(51) Int. Cl. G06Q 10/00; B60P 3/025; B62D 63/08; G09F 19/00; G06Q 30/00

(52) U.S. Cl. 705/9; 296/24.3; 40/1; 705/28; 705/14.4

(57) ABSTRACT

A mobile storage system including: a trailer adapted for towing by a vehicle; and a storage compartment removably mounted on the trailer, said compartment including a base, a roof, a front wall, a rear wall and a pair of side-walls; and doors disposed on at least the rear wall and at least one of the side walls, wherein the doors are adjustable between at least opened and closed positions; and a ramp positionable adjacent the storage compartment in order to provide for wheeled access into the storage compartment via at least one of the doors.

### TECHNICAL FIELD

The present invention relates to a storage system and in particular, a mobile storage system for use in storing and/or transporting property from one premises to another. The present invention also relates to a method of managing the use of the mobile storage systems.

### BACKGROUND OF THE INVENTION

When moving home or office, property is removed from an old premises, loaded into a removal truck, transported to the new premises, and then unloaded from the removal truck into the new premises.

Problems tend to arise during the loading and unloading of the truck. For instance, where the removal truck is parked in a congested street, access to the truck may be obstructed if cars are parked close to the rear of the truck via which the truck is loaded.

Another problem associated with moving premises is that quite often, property needs to be removed from the old premises before the new premises is ready to be occupied. Thus, the property in the truck has to be unloaded at an intermediary location such as a self-storage warehouse. Unfortunately, this requires an additional step of unloading the property from the removal truck into the self-storage unit and then later moving the property from the self-storage unit to the new premises. These additional steps can be an extremely laborious and time-consuming.

In some cases, open-top trailers, “mini-skips” and the like are used to transport property from the customer premises to the warehouse. When such equipment is used, the property is susceptible to theft and damage through rain and is therefore unsuitable for prolonged storage of property. Moreover, trailers and “mini-skips” are typically designed to be towed by specialist vehicles and not by standard vehicles which makes the customer overly-reliant upon a third-party.

### SUMMARY OF THE INVENTION

The present invention seeks to alleviate at least one of the problems described above in relation to the prior art.

The present invention involves several different broad forms. Embodiments of the invention may include one or any combination of the different broad forms herein described.

In a first broad form, the present invention provides a mobile storage system including:

a trailer adapted for towing by a vehicle; and

a storage compartment removably mounted on the trailer, said compartment including a base, a roof, a front wall, a rear wall and a pair of side-walls; and

doors disposed on at least the rear wall and at least one of the side walls, wherein the doors are adjustable between at least opened and closed positions; and

a ramp disposed adjacent to each of the doors, the ramp being selectively adjustable between at least extended and retracted positions relative to the storage compartment, wherein when the ramp is arranged in the extended position, it provides for wheeled access into the storage compartment via its respective door, and, when disposed in the retracted position, it is adapted to be compactly stowed against the storage compartment.

Preferably, a door is disposed on each of the sidewalls. Advantageously, the present invention may allow the storage compartment to be loaded in a more convenient manner in that a trolley may be used to wheel property up the extended ramps if desired. Moreover, by having doors and ramps disposed on multiple sides of the storage compartment, this may improve the general accessibilty of the storage compartment in crowded streets where for instance it may be impractical to load the trailer from the rear because another vehicle may be parked close behind. Thus, when the present invention is parked against a curb, the storage compartment may be conveniently loaded from the rear, the street-side, the sidewalk-side, or from all sides at the same time if required. Moreover, the storage compartment may be conveniently loaded using a wheeled trolley if required from multiple sides of the compartment if necessary.

Preferably, the storage compartment may include a plastic material. Typically the plastic material may include polypropylene or any other suitable plastic material. Advantageously, the plastic material may provide a relatively lightweight structure suitable for towing by a standard vehicle, such as a family sedan or hatchback, yet the material may also provide suitable robustness for bearing the load of stored items without rupturing. A further advantage may be that the use of a relatively lightweight plastic material alleviates the load borne by a forklift when moving the storage compartment from the back of the trailer into a warehouse space for storage.

Typically, the storage compartment may include a substantially rectangular-shaped or cube-shaped configuration. Also typically, the storage compartment may be adapted to accommodate a volume of at least about 16 cubic metres. For instance, in certain embodiments, the dimensions of the storage compartment may include a height of about 2 m, a width of about 2 m and a length of about 4 m.

Preferably, the present invention may also include a mechanism for securing the storage compartment in a substantially fixed position relative to the trailer. Conveniently, this may alleviate the inadvertent displacement of the storage compartment on the trailer during transportation. This may be particularly advantageous where the storage compartment is empty and it is more susceptible to being displaced about on the back of the trailer by wind of erratic motion of the trailer during transport. In certain embodiments, the securing means may include a plurality of latches adapted for securing various points of the compartment to the trailer.

Preferably, the present invention includes a means of selectively displaying advertising indicia on an outer surface of the storage compartment. For instance, this may include a bracket means for releasably receiving advertising banners and the like. Typically, the bracket may be disposed on an outer surface of the storage compartment. Conveniently, any number of disparate advertising themes may be interchangeably displayed on the storage compartment which may assist in improving the flexibility of the present invention as a marketing device.

Preferably, the storage compartment includes a engagement surface adapted for being engaged by a fork-lift or the like so that it may be conveniently removed from the trailer and stowed directly into a warehouse storage bay, garage space or the like in a single step. For instance, the storage compartment may include slots and/or channels which may be adapted to receive the prongs of a forklift when the forklift is lifting the storage compartment from the trailer surface to be stowed in a warehouse space. The slots and/or channels may typically be integrally moulded into the structure of the storage compartment itself. In contrast, prior art approaches involving the use of conventional removal trucks tends to be relatively labour intensive in that individual items such as boxes and the like must be individually loaded into the truck and then once at the destination, must again be individually unloaded for storage into the warehouse storage bay.

Advantageously, the ability to conveniently remove the entire storage compartment from the trailer for storage, alleviates the need to laboriously unload each item within the storage compartment before then having to stow the individual items into the warehouse storage bay. Typically, the storage compartment may be sized to occupy an entire bay or space so that the warehouse space may be efficiently utilised.

Preferably, the trailer includes a coupling means adapted for releasably coupling with a ball-type towing member or the like which may typically be found on a rear section of a standard vehicle. In contrast, certain prior art equipment tend to be adapted for towing only by specialised towing vehicles using specialised tow coupling equipment which may not be readily available to ordinary users. Thus, the present invention may provide added flexibility for the user in that he/she may have the option of towing the present invention with his/her own vehicle if so desired. This provides added convenience and flexibility for the customer because the customer is given the option of moving the mobile storage system at a time of his/her choosing if desired.

Typically, the ramp may serve a dual-function as both a ramp and a door. For instance, the ramp may be pivotably movable relative to a wall of the compartment between at least an opened position and a closed position. When disposed in the closed position, the ramp may be rotated flush into vertical alignment with the compartment wall so as to act as a door which seals over an opening in the wall. Conversely, when in the opened position, the ramp may be rotated away from the compartment wall such that it inclines downwardly to the ground to conveniently allow for trolleys or other wheeled devices to be rolled up the ramp and into the storage compartment if desired. Advantageously, by adapting the door to also serve as a ramp, this may alleviate the overall cost of materials used in manufacturing the storage compartment. Moreover, the storage compartment may be rendered more compactable given that the ramp would not unnecessarily occupy space within the storage compartment when not in use which may otherwise be better utilised for storing property.

In alternative embodiments of the present invention, the ramp may be provided as a separate structure to that of the door. For instance, it may be that the ramp is a stand-alone structure slidably positionable relative to the storage compartment and which may be extended outwardly of the compartment when the door is opened.

The doors may be manually adjustable, or, in some embodiments, powered either electrically, hydraulically, or pneumatically.

In certain embodiments of the present invention, the storage compartment may include a light source for illuminating the storage compartment. Typically, the light source may be powered via a standard 12-volt battery of the towing vehicle. Alternatively, the light source may be solar-powered from a solar-cell disposed on an external surface of the storage compartment—for instance, the roof.

In a second broad form the present invention provides a method of managing the use of storage systems described in accordance the first broad form of the present invention, the method being operable via a computerised system, and including the steps of:

(i) presenting a plurality of available mobile storage systems for potential use by a customer; and

(ii) thereafter, receiving in the computerised system a customer request to use one of the mobile storage systems; and

(iii) thereafter, in response to the received customer request, the computerised system selectively authorising use of a mobile storage system by the customer if an authorisation criteria is met, wherein if the authorisation criteria is met, the customer is able to collect the mobile storage system from one of a plurality of available collection stations and load the storage compartment of the system with property at a customer premises; and

(iv) thereafter, receiving in the computerised system a customer request to collect and transport the loaded storage system from a customer premises to the warehouse for storage; and

(v) thereafter, the computerised system automatically instructing a courier to transport the loaded storage system from the customer premises to the warehouse where the loaded storage system is thereafter stored directly into a warehouse bay.

Typically, the computerised system includes a central server including a memory store containing a program executable by the central server to perform at least some of the method steps in accordance with the second broad form of the present invention. The central server may also include a database for storing information available for use by the central server in performing at least some of the method steps of the second broad form of the present invention. For instance, the database may receive and store information in real-time relating to at least one of the following:
(a) a location and/or availability status of warehouse spaces at any given time;
(b) a location and/or availability status of a courier at any given time;
(c) locations of collection stations;
(d) the number and availability of mobile storage systems at each of the collection stations at any given time;
(e) customer information including the location of a customer premises from where the loaded storage system is to be collected and transported to a warehouse;
(f) the storage location of customer property in a warehouse and/or the duration of time the customer property is to be stored in the warehouse space;
(g) statistical information relating to the revenue generated from various collection stations, revenue generated in various geographic regions, and so on.

The information contained within the database may be updated in real-time by receiving messages from couriers, warehouses, customers, and/or collection stations periodically, or, whenever an operating status changes so as to ensure that the information contained within the database is kept relevant. For instance, when a courier is selected to transport customer property from a given location, and accepts the assignment, the courier may instruct the central server that it is temporarily engaged.

Typically, the present invention includes the step of at least some of the couriers, the warehouses, customers, and third-party collection stations being provided with client terminals. A client terminal may include a PC, a mobile phone, PDA or the like which may include a processor, display means, and input means adapted to communicate with the central server via a signalling network. The signalling network may include means for communicating across a wired and/or wireless communication link and may typically use at least one of the following messaging formats:

(a) e-mail;

(b) Short Message Service;

(c) facsimile;

(d) voice communication;

The computerised system may also include a Web server for hosting a Web site that is accessible via the signalling network using a Web browser application running on at least one of the client terminals.

In step (I), by way of example only, the collection stations may include the shop-front premises of third-party organisations, including at least one of:

(a) a service station;

(b) a hardware store;

(c) a supermarket; or

(d) a convenience store.

For instance, at any one time, at least two or three storage systems may typically be provided for collection by customers from various service stations within an established network of service stations such as “BP”™, “Shell”™ or the like. Advantageously, by utilising the premises of an established network of vendors as collection stations, this may reduce the costs which would otherwise be incurred in setting up a new network of shop-fronts.

In step (i), the Web site of the computerised system may be used to display a listing of available mobile storage systems. The listing may be searchable by reference to such as factors as the location of the customer premises where the storage system is to be used, the time/date when the storage system is required by the customer, and so on. Therefore, it is conceivable that a customer may conveniently access the Web site listing via a WAP-enabled mobile phone, via the Internet using a PC, or, via a client terminal located at a collection station.

In accordance with step (ii) of the second broad form, the customer request is preferably sent to the central server for processing via the Web site. For instance, the Web site may typically include a form which is to be completed online by the customer and submitted via the signalling network to the central server for processing. The form may prompt the customer to enter information such as:
(a) the customer's personal details including his/her name and contact details;
(b) a specific location of the collection station from where the customer seeks to collect a storage system for use; and/or
(c) a location of the customer premises from where the storage system will be loaded; and/or
(d) a time/date when the storage system is required by the customer; and/or
(e) an indication as to whether the mobile storage system is intended for purchase or for lease, and if for lease, the duration of the requested lease; and/or
(f) a location of a specific warehouse nominated by the customer where the customer wishes to have the property stored, or, and indication that the computerised system should automatically allocate a warehouse based on customer preferences;
(g) an estimated time duration in which the customer is seeking to store the storage system in the warehouse;
(h) billing account details of the customer to enable automatic debiting of the account whenever a fee is payable by the customer;

Upon receiving of the customer request, the computerised system may store this information in the database for future reference.

Preferably, in step (iii), the authorisation criteria which may be met before the customer receives authorisation to use the mobile storage system includes the customer having to pay a fee. Typically, payment of the fee by the customer may result in the customer obtaining a lease for the storage system. The fee payable for the lease may vary depending upon the duration requested by the customer for leasing the storage system. Alternatively, the fee that is payable by the customer may result in the outright purchase of the storage system.

Typically, payment of the fee may be effected at the same time that the customer request is submitted for processing. For instance, the Web site may allow the customer to submit credit card details on the online customer request form. The credit card details may be processed by the central server upon receipt: Typically, a suitable security protocol may be implemented across the signalling to alleviate the risk of unauthorised access to customer credit card details. Alternatively, payment of the customer fee may be manually effected using an electronic payment system such as EFTPOS available at any participating collection station. Typically, a portion of the fee payable by the customer may be allocated to the participating third-party as a kick-back. Advantageously, third-party shop-fronts may, in many instances, be readily able to accommodate a number of storage systems at any given time at little or no cost to the third-party, and, the opportunity to receive a kick-back for each storage system used by a customer may therefore serve as a compelling incentive for the third-party to participate in the scheme.

Typically, after payment has been successfully processed, a confirmation message may be automatically sent to the customer from the central server so that the customer is aware that he/she is now free to collect the storage system for use. Typically, for convenience, if the customer submits the payment via the online Web site, the confirmation message may be displayed on the Web site. Alternatively, the confirmation message may be conveniently sent to the customer via an SMS or e-mail message. The confirmation message may also, for the customer's reference, include information such as the time and place where the storage system is to be collected by the customer, details of the location of the customer premises from where the loaded storage system is to be collected from, and so on.

Thereafter, when the customer has been authorised to collect a given mobile storage system from a collection station, the central server may be programmed to automatically instruct a supplier to deliver a replacement mobile storage unit to the collection station. Replacement mobile storage system may for instance be dispatched from a factory to a given collection station whenever the central server detects that a mobile storage system has been leased or purchased from the collection station.

Thereafter, when the customer has paid for use of the storage system, the customer is able to tow the storage system to its customer premises from the specified collection station for loading using the customer's standard vehicle if desired. In contrast to certain prior art systems, the present invention tends to provide greater flexibility for the customer in that the customer need not require a truck with specialised towing equipment to tow the storage system to the customer's premises which can be time-consuming. Also, the relative lightweight nature of the storage compartment tends to make it easier for a standard vehicle to tow.

In step (iv) of the second broad form, the customer request to collect and transport the loaded storage system may typically be sent via an SMS and/or verbal communication. Whilst other forms of communication may be utilised, the customer may find that the use of a SMS in this instance is particularly convenient. Preferably, the computerised system may, upon receiving and processing the customer request, send a confirmation message to the customer. The confirmation may also be sent to the customer via SMS for convenience.

Step (v) typically includes the step of providing a plurality of couriers, any one of which may be selected to tow the customer's loaded storage system to the warehouse from the customer premises. Preferably, step (v) includes the customer server automatically determining in real-time, a relative proximity and/or availability status of each of the couriers to the customer premises where the loaded storage system is intended to be collected from. This step may be carried out by reference to the updated information contained in the database. Typically, the relative proximities of each courier may be determined by reference to a Global Positioning System (GPS) where for instance, each courier may be equipped with a portable GPS tracking device to enable a determination of its position. The position of each courier as determined by reference to the GPS system may be periodically monitored by the central server via the communication system.

Alternatively, in step (V), the computerised system may be adapted to automatically select a courier from amongst a plurality of couriers to tow the customer's loaded storage system, by conducting an auction in which couriers are able to bid for the job of towing the customer's storage system. Preferably, in bidding for the job, couriers may be required to submit their cost estimate for towing the customer's loaded storage system. Typically, the auction may be concluded after a predefined time period and the courier which has submitted the lowest cost estimate is automatically selected to tow the customer's loaded storage system. The winning courier may be automatically advised as to its winning bid via an SMS, e-mail or the like that is generated and transmitted by the computerised system.

The computerised system may be programmed to automate the implementation of the auction. By way of example only, whenever a customer request is received by the computerised system for a courier to collect a loaded storage system from the customer premises, the computerised system may perform the following steps:
(a) initiating the auction by advertising details of the customer request (e.g. location of customer premises, and location of destination warehouse, time of pick-up and so on), a deadline by which bids for the job from couriers should be received in order to be processed, and a maximum cost that will be payable for the job; and
(b) thereafter, receiving bids from couriers in response to the auction advertisement; and
(c) thereafter, when the predetermined deadline has elapsed, processing received bids having cost estimates below the maximum cost and determining a winner based on the lowest cost estimate submitted; and
(d) alerting the winning courier of its winning status via e-mail, SMS or the like.

Typically, for each auction that is active, information relating to the status of the auction may be displayed on the Web site. For instance, the information may include at least one of the following:
(a) job details including the location of the customer premises, warehouse destination details, and requested time of pick-up of the storage system from the customer premises; and/or
(b) a maximum price that will be paid to a customer for performing the job; and/or
(c) the current total number of bids received in the auction to date;
(d) a listing of at least some of the bids received by the computerised system to date and/or with an indication of the time at which each bid was submitted;
(e) the best bid received in the auction to date;
(f) the deadline for completion of the auction, and/or, an indication of the time remaining before the auction will end.

In certain embodiments, details of each auction may be advertised to couriers via an SMS, e-mail or the like as they arise. Similarly, interested couriers may thereafter be able to submit their bids for the job to the computerised system for processing via SMS, e-mail or the like. The computerised system may send the couriers message updates which outline the current status of any given auction. The message update may for instance include similar information as is described above in points (a) to (f).

Preferably, the present invention also includes the step of providing a plurality of geographically dispersed warehouses, any one of which may be selected for stowing the customer's loaded storage system. Preferably, step (v) also includes the step of automatically determining a relative proximity of each of the warehouse locations to the customer premises where the loaded storage system is intended to be collected from, and/or, and/an availability status of each warehouse. The present invention may thereafter, instruct the selected courier to transport the loaded storage system to the warehouse which may be closest to the customer's premises. For convenience, the selected courier may be contacted by the computerised system automatically via an SMS message. When the courier accepts the assignment, he/she may send a confirmation message back to the central server again—preferably by way of an SMS or the like for convenience. Thereafter, the computerised system may update the information contained in the database—for instance, to indicate that the selected courier is no longer available. In some cases, the present invention may not automatically instruct the courier to transport the loaded storage system to the nearest available warehouse to the customer's premises, but may instead direct the courier to transport the loaded storage system to a warehouse specifically selected by the customer. The customer may for instance be able to nominate a specific warehouse for storage of its property at the time the initial customer request for a storage system is submitted online via the Web site.

Preferably, once delivered to a warehouse by a courier, the storage compartment of the storage system may be lifted from the trailer by a forklift and loaded directly into a storage bay of the warehouse in a single step. This conveniently allows for an efficient one-step approach to storing the customer's property in the warehouse which alleviates the need to unload each individual item in the storage compartment and then transfer the items of property into the storage bay of the warehouse. Once stored, the warehouse may automatically instruct the central server as to the precise storage location of the customer's property within the warehouse.

Preferably, the present invention may also include the step of selectively displaying advertising indicia on the storage systems, wherein the advertising indicia may be representative of a logo, brand, or trade mark, associated with the third-party which is being used as a collection station for the storage system in question. The opportunity for the third-party to receive, what is in effect, free advertising may provide yet a further incentive for the third-party to participate in the scheme. It would be apparent to a person skilled in the art that the advertising which is selectively displayed on the storage systems need not necessarily be associated with the third-party vendor from which the storage system is collected.

Preferably, the present invention may also include the step of providing an automated quoting system which may assist customers in ascertaining an estimate of costs involved in for instance having a leased or purchased storage system towed to the customer premises. The storage system which is sought to be delivered to the customer premises may already be loaded with customer property and may need to be transported from a warehouse to the customer premises so that the customer may retrieve a particular item from the storage system. Alternatively, the storage system may be newly leased or purchased and has yet to be loaded with the customer's property.

In either case, in order to generate a quote, the customer may be required to submit details of the requested delivery into the computerised system including:
(a) the requested time of the delivery;
(b) the duration of time the storage system is required at the customer premises;
(c) the location of the customer premises where the storage system is to be delivered;
(d) an indication as to whether the storage system is currently being held at a warehouse (and if so, the warehouse location), or, whether the storage system has been recently leased or purchased as new and is to be delivered from a specified collection station to the customer premises (and if so, the location of the collection station from where the storage system is to be collected from).

The above details may be submitted to the computerised system via the Web site interface, or alternatively, may be submitted to the computerised system via an SMS or e-mail message for convenience. Typically, the computerised system may process the received customer delivery query in order to generate a quote, and, may return the quote to the customer via the Web, SMS or e-mail. In some cases, the quote may be generated in general terms by comparing the details of the customer query to a look-up table, or, the quote may be relatively specific and involve applying a more formula using the specific details of the customer query as inputs.

The present invention may further provide a step of allowing customers to track the movement of storage systems that they have leased or purchased as they are being transported by a courier. For instance, as described above, real-time information may be maintained in the database relating to the location of couriers using a GPS tracking system. Therefore, a customer may be able to submit a tracking request to the computerised system typically via SMS, e-mail, WAP, or the Web site interface, wherein the request may identify the courier that is transporting the customer's property. Typically, couriers may be assigned a unique ID number in order to make it easier for customer's to identify them. Upon receiving the customer's tracking query, the database may be queried in order to determine the most recent GPS co-ordinates of the courier in question, and thereafter, these details may be sent to the customer via a suitable messaging format such as e-mail, SMS or the like. The messaging format may include a text message indicating the location of the storage system being towed, or alternatively, the message may include a graphical representation of the location of the storage system in transit. The graphical representation may for instance include a map having a pointer displayed thereon to indicate the location of the storage system by reference to the map coordinates.

Preferably, the present invention may also provide the step of recording in the computerised system an inventory list of items that have been stored in a loaded storage system. Typically, the inventory list may be recorded into the computerised system by a customer that has leased or purchased the storage system in question. For instance, during or after loading of the storage system, the customer may submit the inventory list into the computerised system via the Web site interface whereby the inventory list may be stored in the database of the central server with other personal account information of the customer.

Typically, the Web site interface may allow the customer to enter details identifying each stored item using at least one of:

(a) a written description of each stored item; and/or

(b) an image of each stored item.

Each storage compartment of each storage system used in accordance with the present invention may be assigned a unique identification number. The unique identification number may also be associated with the inventory list before being submitted so that the computerised system is able to correctly track the location of customer property for each customer.

In regard to (b), the customer may attach a digital thumbnail photograph of each item that is loaded into the storage system. After the form has been submitted and the inventory list has been stored in the database of the central server, the customer may later retrieve and view the inventory list via the Web site or via a WAP browser running on the customer's mobile phone.

Typically, the customer may be required to log into the Web site using a designated username and password in order to ensure that the customer's privacy is maintained.

The customer may request, via the Web site, that any one of the displayed items in the inventory may be automatically placed for sale via an online trading site such as www.ebay.com or www.amazon.com. For instance, this may be automated by the computerised system in accordance with the following sub-steps:
(a) receiving a customer instruction which may specify an item in the inventory list that is to be placed for sale via the online trading site, and/or, a minimum price that the item should be sold at; and
(b) thereafter, automatically interfacing with the online trading site so as to enable the item to be advertised for sale on the online trading site in accordance with the customer's instructions—this may also involve the computerised system automatically providing the online trading site the relevant written description of the item for sale and/or image of the item contained in the inventory list; and
(c) thereafter, upon completion of sale of the item via the online trading site, the computerised system may be programmed to automatically notify the relevant warehouse that the purchaser may be allowed to access the sold item from the customer's storage system.

In some cases, the computerised system may also be responsible for receiving funds generated by the sale of the customer's item. For instance the funds may be paid from the online trading site into a bank account administered by the computerised system. If this is the case, then typically, the funds may forwarded by the computerised system to the a bank account of the relevant customer. A portion of the funds may be retained as a commission fee for effecting automated sale of the item online.

### BRIEF DESCRIPTION OF THE DRAWINGS

The present invention will become more fully understood from the following detailed description of a preferred but non-limiting embodiment thereof, described in connection with the accompanying drawings, wherein:

FIG. 1A depicts a mobile storage unit in accordance with a first embodiment of the present invention;

FIG. 1B depicts the mobile storage unit in FIG. 1B with the side door closed and an advertising flap hanging over the closed door to display a removable advertising banner.

FIG. 2 depicts a functional overview of a computerised system used in accordance with a second embodiment of the present invention;

FIG. 3 shows a flow diagram indicative of method steps performed in accordance with the second embodiment of the present invention.

### MODES FOR CARRYING OUT THE INVENTION

A mobile storage unit in accordance with a first embodiment will be described below. A method managing the use of mobile storage units so as to generate revenue is also described below in accordance with a second embodiment of the present invention.

The first embodiment mobile storage unit includes a trailer (2) adapted for towing by a vehicle (3) and a storage compartment (4) removably mounted on the trailer (2). The storage compartment (4) is substantially rectangular-shaped and includes a base (4a), a roof (4b), a front wall (4c), a rear wall (4d) and a pair of side-walls (4e). In this embodiment, the storage compartment (4) includes a volume of about 16 cubic metres whereby the height is about 2 m, its width is about 2 m, and, its length is about 4 m.

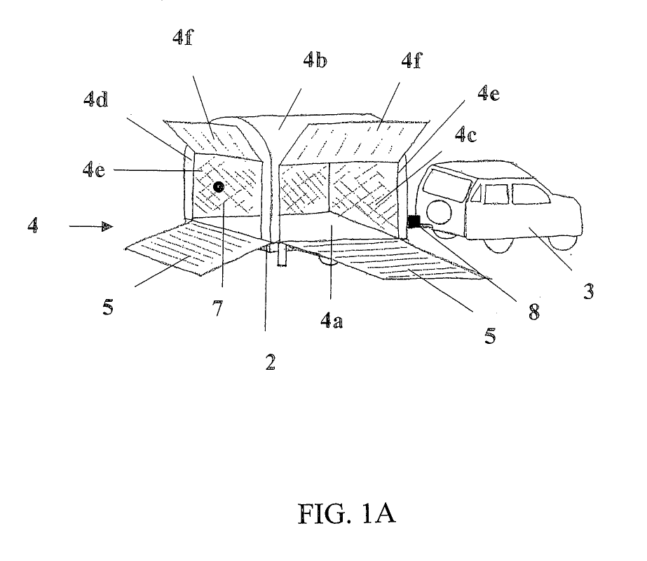

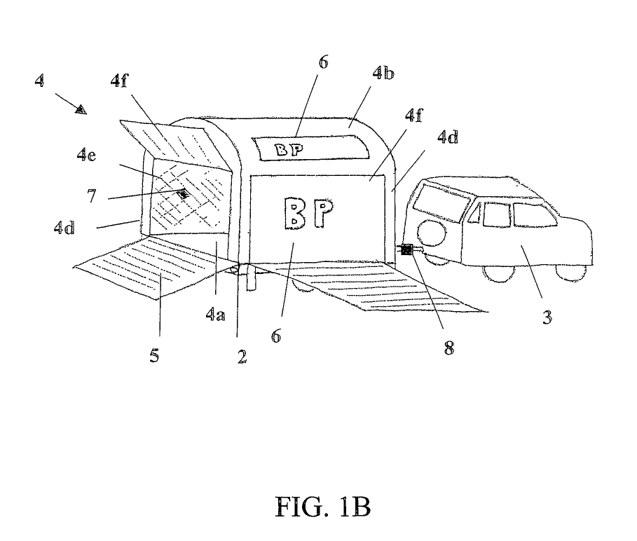

The storage compartment (4) also includes doors (5) disposed on the rear wall (4d), and, both the side-walls (4e). The doors (5) are adjustable between opened and closed positions so as to selectively allow access into the storage compartment (4) for loading via multiple sides of the storage compartment (4). The doors (5) serve an additional function as loading ramps (5) when they are arranged in the opened position. FIG. 1 shows a door of one sidewall (4e), and, a door of the rear wall (4d) arranged in the opened position. When opened, the doors (5) are downwardly inclined to the ground so that, if desired, a user is able to conveniently wheel a trolley or the like up the ramp (5) to load the storage compartment (4).

In FIG. 1 it can also be seen that advertising flaps (4f) are disposed at each doorway. The advertising flaps (4f) are designed to hang over the doorways after the doors have been rotated into closed positions. Interchangeable advertising displays (6) are mounted on the flaps (4f) so that they are visible during transport. In this example, the distinctive “BP” logo is shown mounted on the advertising flap (4f):

The storage compartment (4) includes a moulded polypropylene material which is suitably lightweight for towing by the standard vehicle (3), whilst at the same time, being suitably robust for bearing the load of stored items.

The storage compartment (4) also includes a bracket (6) for releasably receiving advertising banners and the like. The bracket (6) is disposed on an outer surface of the storage compartment to ensure maximum exposure of the advertising. This allows any number of disparate advertising themes to be interchangeably displayed on the storage compartment (4) as required.

The storage compartment (4) also includes an engagement surface adapted for being engaged by a fork-lift or the like so that it can be lifted from the trailer and stowed directly into a warehouse storage bay, garage space or the like in a single step. The engagement surface includes a pair of channels moulded into the plastic material which are adapted to receive the prongs of a forklift.

The storage compartment (4) also includes a light source (7) for illuminating the storage compartment (4). The light source (7) is wired to, and powered by, a standard 12-volt battery of the towing vehicle (3).

The trailer (2) includes a towing member (8) which is suitable for coupling with a ball-type towing member of the standard vehicle (3) such as is used to tow a caravan or a boat.

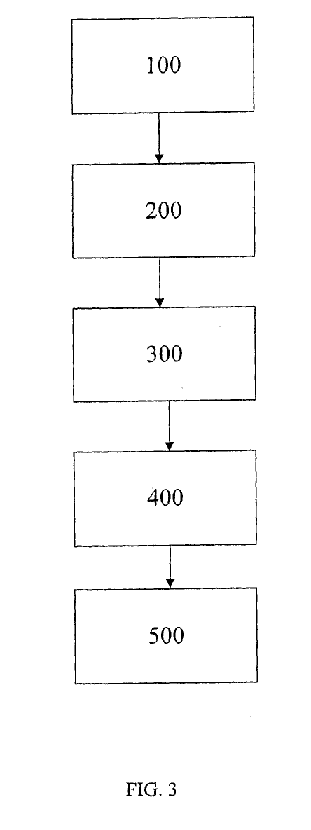

FIG. 3 shows a flow-chart which broadly outlines a series of method steps in accordance with a second embodiment of the present invention, wherein the method involves the use of a plurality of first embodiment mobile storage units to generate revenue. Specifically, the second embodiment provides a method, of managing the use of a plurality of first embodiment mobile storage units, wherein the method is operable via a computerised system, and includes the steps of:

(i) presenting a plurality of available mobile storage units for potential use by a customer. This step is indicated at block 100 in FIG. 3; and

(ii) thereafter, receiving in the computerised system a customer request to use one of the mobile storage units; This step is indicated at block 200 in FIG. 3; and

(iii) thereafter, in response to the received customer request, the computerised system selectively authorising use of a mobile storage unit by the customer if an authorisation criteria is met, wherein if the authorisation criteria is met, the customer is able to collect the mobile storage system from one of a plurality of available collection stations and load the storage compartment of the unit with property at a customer premises; This step is indicated at block 300 in FIG. 3; and

(iv) thereafter, receiving in the computerised system a customer request to collect and transport the loaded storage system from a customer premises to the warehouse for storage; This step is indicated at block 400 in FIG. 3; and

(v) thereafter) the computerised system automatically instructing a courier to transport the loaded storage system from the customer premises to the warehouse where the loaded storage system is thereafter stored directly into a warehouse bay. This step is indicated at block 500 in FIG. 3;

The computerised system includes a central server (9) including a memory store containing a program executable by the central server (9) to perform the method steps in accordance with the second embodiment. The central server (9) also includes a database (10) for storing information available for use by the central server (9) in performing the method steps of the second embodiment. Specifically, the database (10) is adapted to receive and store information in real-time relating to at least the following:
(a) the location and/or availability status of warehouse spaces at any given time;
(b) the location and/or availability status of each courier at any given time;
(c) the locations of collection stations;
(d) the number and availability of mobile storage units at each of the collection stations at any given time;
(e) customer information including the location of a customer premises from where the loaded storage system is to be collected and transported to a warehouse;
(f) the storage location of customer property in a warehouse and/or the duration of time the customer property is to be stored in the warehouse space;
(g) statistical information relating to the revenue generated from various collection stations, revenue generated in various geographic regions and so on.

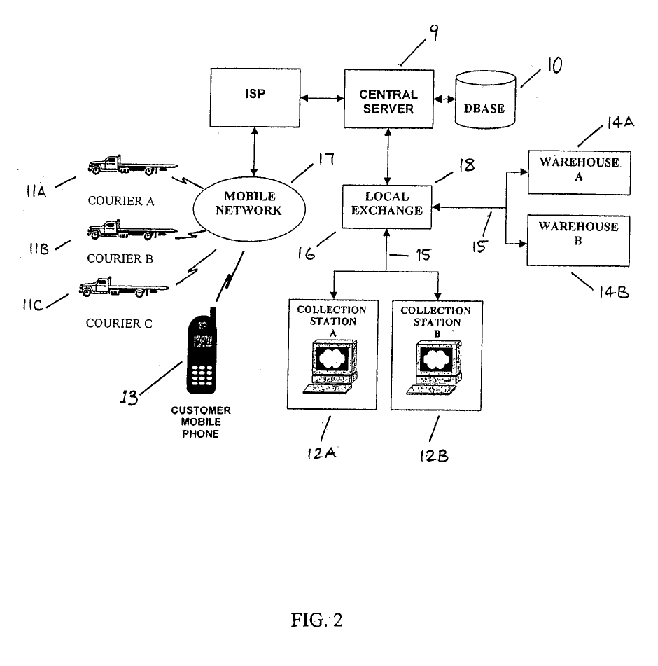

The information contained within the database (10) is updated in real-time by periodically receiving messages from a plurality of geographically dispersed couriers (11A-11C) warehouses (14A, 14B) and collection stations (12A,12B) so as to ensure that the information within the database (10) is kept relevant. For instance, when a courier (11A-11C) is selected to transport customer property from a customer premises, and it accepts the task, the courier instructs the central server (9) that it is temporarily unavailable to perform other services. In FIG. 2, a customer is represented by the customer's mobile phone (13).

The method also includes the step of each of the couriers (11A-11C), the warehouses (14A-14B), the customer (13), and third-party collection stations (12A,12B) being provided with client terminals. The client terminals include PCs, mobile phones, PDAs and the like which have a processor, display means, and input means adapted for communication with the central server via a signalling network. Referring to FIG. 2, and by way of example only, the client terminals include PC terminals located at each of the collection stations (12A,12B) which are free to use by the customer to communicate with the central server (9). The customer mobile phone (13) also serves as a client terminal which allows the customer to communicate with the central server (9) either via an SMS based protocol, or using voice communication.

The signalling network is adapted to facilitate communication utilising all of the following communication protocols:

(e) e-mail;

(f) Short Message Service;

(g) facsimile;

(h) voice communication.

One aspect of the signalling network in this embodiment includes a mobile phone network (17) which enables the couriers (11A-11C) and the customer mobile phone (13) to interface with the central server (9) via mobile phone devices. The customer for instance is able to use both the WAP-enabled mobile phone (13) to submit customer requests to the central server (9) in addition to using any one of the client terminals located at the third-party collection stations (12A,12B). The warehouses (11A,11B) and collection stations (12A,12B) are able to interface with the central server via another aspect of the signalling network—that is, via ISDN lines (15) linking the collection stations (12A,12B) to a local phone exchange (18) which in turn is connected to the central server (9).

The central server (9) also includes a Web server for hosting a Web site that is accessible via the signalling network using Web browser applications running on each of the client terminals. A customer can conveniently access the Web site listing via the WAP-enabled mobile phone (13), via the Internet using a PC, or, via any one of the client terminals located at the third-party collection stations (12A,12B).

In step (I), the collection stations (12A,12B) include the shop-front premises of third-party organisations, such as service stations and hardware stores. At any one time, a minimum of four storage systems are provided for collection by customers from each of the collection stations (12A,12B). Each storage unit parked at a given third-party collection station (12A,12B) is provided with advertising indicia indicative of a logo of the third-party.

The Web site provides a listing of available mobile storage units at each of the collection stations (12A,12B) at any given time. The listing is searchable by reference to, amongst other things, the location of the customer premises where the storage system is to be used, and, the time/date when the storage system is required by the customer.

In accordance with step (ii), the customer request is sent to the central server (9) for processing via the Web site. The Web site includes the step of presenting a form which is to be completed online by the customer and submitted electronically for processing. The form prompts the customer to enter information including the following:
(a) a specific location of the collection station from where the customer seeks to collect a storage system for use; and/or
(b) a location of the customer premises from where the storage system will be loaded;
(c) a time/date when the storage system is required by the customer;
(d) an indication as to whether the mobile storage system is intended for purchase or for lease, and if for lease, the duration of the requested lease;
(e) a location of a specific warehouse nominated by the customer where the customer wishes to have the property stored, or, and indication that the computerised system should automatically allocate a warehouse based on customer preferences;
(f) a location of where to pick up the loaded storage system;
(g) a time at which the loaded storage system is to be picked up.

Upon receiving of the customer request, the central server (9) stores this information in the database (10) for future reference.

In step (iii), the authorisation criteria includes the customer having to pay a fee to lease the requested mobile storage unit. The fee payable for the lease will vary depending upon the lease duration requested by the customer. Payment of the fee is effected at the same time that the customer request is submitted for processing. This involves the customer including his/her credit card details on the online customer request form when a request to use a mobile storage unit is first submitted. The credit card details are processed by the computerised system upon receipt and if accepted, a confirmation message is displayed on the client terminal so that the customer is notified that he/she is now free to collect the storage system for use. The confirmation includes details of the time and place where the storage system is to be collected by the customer, details of the location of the customer premises from where the loaded storage system is to be collected from, and so on.

A portion of the fee paid by the customer is allocated to the third-party collection stations (12A,12B) from where the mobile storage unit is collected which may, in many instances, be readily able to accommodate a number of storage systems at any givern time at little or no cost to the third-party, and, the opportunity to receive a kick-back for each storage system used by a customer may therefore serve as a compelling incentive for the third-party to participate in the scheme. The allocation of kick-backs to the third-party collection stations is generally effected at the end of each calendar month for simplicity and will generally involve a direct electronic transfer of the third-party's allocated funds to a nominated bank account. The amount of the kick-backs which are payable to the various collection stations (12A,12B) can be determined by reference to information which has been periodically stored in the database (10) of the central server (9).

Thereafter, when the customer has paid for use of the storage system, the customer tows the storage system to its customer premises from the specified collection station for loading using the customer's standard vehicle if desired. After loading the mobile storage unit, the customer send a further request via an SMS to collect and transport the loaded storage unit. The customer will indicate the location of a specific warehouse where the storage unit is to be transported to, or alternatively, will request that the computerised system automatically allocate a warehouse for storage.

In the second embodiment, step (v) also includes the step of providing a plurality of couriers, any one of which is able to be selected, if available, to tow the customer's loaded storage system to the nominated warehouse from the customer premises. Step (v) involves the computerised system, upon receiving the customer request, automatically determining a relative proximity and/or availability status of each of the couriers to the customer premises where the loaded storage system is intended to be collected from. The relative proximities of each courier is determined by reference to a Global Positioning System (GPS) where for instance, each courier is equipped with a portable GPS tracking device to enable a determination of its position. The position of each courier as determined by reference to the GPS system is periodically monitored by the computerised system and stored in the database for future reference.

The second embodiment further includes the step of providing a plurality of geographically dispersed warehouses, any one of which is able to selected for stowing the customer's loaded storage unit. Step (v) also includes the step of automatically determining a relative proximity of each of the warehouse locations to the customer premises where the loaded storage system is intended to be collected from, and/or, and/an availability status of each warehouse. The courier is instructed to transport the loaded storage unit to the warehouse which may be closest to the customer's premises. For convenience, the selected courier is contacted by the computerised system automatically via an SMS message. When the courier accepts the assignment, he/she send a confirmation message back to the central server again via an SMS for convenience. Thereafter, the computerised system update the database to indicate that the selected courier is no longer available.

Once delivered to a warehouse by a courier, the storage compartment of the storage system is lifted from the trailer by a forklift and loaded directly into a storage bay of the warehouse in a single step. Thereafter, the warehouse sends a message to the computerised indicating the storage location of the customer's property within the warehouse. This information is stored in the database for future reference.

Those skilled in the art will appreciate that the invention described herein is susceptible to variations and modifications other than those specifically described without departing from the scope of the invention. All such variations and modification which become apparent to persons skilled in the art, should be considered to fall within the spirit and scope of the invention as broadly hereinbefore described. It is to be understood that the invention includes all such variations and modifications. The invention also includes all of the steps and features, referred or indicated in the specification, individually or collectively, and any and all combinations of any two or more of said steps or features.

The reference to any prior art in this specification is not, and should not be taken as, an acknowledgment or any form of suggestion that that prior art forms part of the common general knowledge.

1. A mobile storage system including:
a trailer adapted for towing by a vehicle;
a storage compartment removably mounted on the trailer, said compartment including a base, a roof, a front wall, a rear wall and a pair of side-walls;
doors disposed on at least the rear wall and at least one of the side walls, wherein the doors are adjustable between at least opened and closed positions; and
a ramp positionable adjacent the storage compartment in order to provide for wheeled access into the storage compartment via at least one of the doors;
wherein, in use, the storage compartment is loaded with items at a premises, the mobile storage system is transported to a warehouse, the storage compartment containing the items is removed from the trailer, and the storage compartment is deposited directly into a warehouse space.

2. A mobile storage system as claimed in claim 1, wherein the ramp is selectably adjustable between at least an extended and a retracted position relative to the storage compartment wherein, when arranged in the extended position, the ramp provides for wheeled access into the storage compartment via at least one of the doors, and, when arranged in the retracted position, the ramp is adapted to be compactly stowed adjacent to the storage compartment.

3. A mobile storage system as claimed in claims 1, wherein a door is disposed on each of the sidewalls.

4. A mobile storage system as claimed in claim 1, wherein the storage compartment includes a plastic material.

5. A mobile storage system as claimed in claim 1, wherein the storage compartment includes at least one of a substantially rectangular-shaped or cube-shaped configuration.

6. A mobile storage system as claimed in claim 1, wherein the mobile storage system includes a mechanism for releasably securing the storage compartment in a substantially fixed position relative to the trailer.

7. A mobile storage system as claimed in claim 6, wherein the mechanism for releasably securing the storage compartment in a substantially fixed position relative to the trailer includes at least one latch.

8. A mobile storage system as claimed in claim 1, wherein the mobile storage system includes a means of selectively displaying advertising indicia on an outer surface of the storage compartment.

9. A mobile storage system as claimed in claim 8, wherein the means of selectively displaying advertising indicia includes a bracket for releasably receiving advertising banners and the like.

10. A mobile storage system as claimed in claim 1, wherein the ramp is adapted to also function as a door of the storage compartment.

11. A mobile storage system as claimed in claim 10, wherein the ramp is rotatably movable relative to the storage compartment.

12. A mobile storage system as claimed in claim 10, wherein the ramp is slidably movable relative to the storage compartment.

13. A mobile storage system as claimed in claim 1, wherein the mobile storage system includes a means of automatically adjusting the door.

14. A mobile storage system as claimed in claim 1, wherein the mobile storage system includes a light source for illuminating the storage compartment.

15. A method of managing the use of a plurality of mobile storage systems as claimed in claim 1, the method being operable via a computerised system, and including the steps of:
(i) presenting a plurality of mobile storage systems for potential use by a customer; and
(ii) thereafter, receiving in the computerised system a customer request to use one of the mobile storage systems; and
(iii) thereafter, in response to the received customer request, the computerised system selectively authorising use of a mobile storage system by the customer if an authorisation criteria is met, wherein if the authorisation criteria is met, the customer is able to collect the mobile storage system from one of a plurality of available collection stations and load the storage compartment of the system with property at a customer premises; and
(iv) thereafter, receiving in the computerised system a further customer request to collect and transport the loaded storage system from a customer premises to a warehouse for storage; and
(v) thereafter, the computerised system automatically instructing a courier to transport the loaded storage system from the customer premises to the warehouse where the loaded storage system is thereafter stored directly into a warehouse bay.

16. A method as claimed in claim 15 wherein the computerised system includes a central server having a database.

17. A method as claimed in claim 16 wherein the database is adapted to store information relating to at least one of the following:
(a) a location and/or availability status of spaces in the warehouse;
(b) a location of a courier;
(c) an availability status of a courier;
(d) locations of collection stations;
(e) a number and availability status of mobile storage systems located at each of the collection stations;
(f) customer information including the location of a customer premises from where the loaded storage system is to be collected and transported to the warehouse;
(g) the storage location of customer property in a warehouse and/or the duration of time the customer property is to be stored in the warehouse space;
(h) statistical information relating to at least one of, revenue generated from collection stations, and, revenue generated in various geographic regions.

18.-52. (canceled)

53. A method of storing items from a premises into a warehouse space of a warehouse, the method being operable using a mobile storage system including:
a trailer adapted for towing by a vehicle; and
a storage compartment removably mounted on the trailer, said compartment including a base, a roof, a front wall, a rear wall, and a pair of side-walls; and
doors disposed on at least the rear wall and at least one of the side walls, wherein the doors are adjustable between at least opened and closed positions; and
a ramp positionable adjacent the storage compartment in order to provide for wheeled access into the storage compartment via at least one of the doors; wherein the method includes the steps of:
(a) loading the storage compartment with the items at the premises;
(b) transporting the mobile storage system to the warehouse;
(c) removing the loaded storage compartment from the trailer and depositing the loaded storage compartment directly into the warehouse space.

54. A method as claimed in claim 53 wherein the warehouse space is adapted to snugly complement the storage compartment when the storage compartment is deposited in the warehouse space.

55.-58. (canceled)
